(19) United States
(12) Patent Application Publication
(10) Pub. No.: US 2020/0064292 A1
(43) Pub. Date: Feb. 27, 2020

(54) GAS SENSOR AND METHOD OF MAKING THE SAME

(71) Applicant: National Taiwan Normal University, Taipei City (TW)

(72) Inventors: Tien-Li CHANG, Taipei City (TW); Cheng-Ying CHOU, Taipei City (TW); Chi-Huang HUANG, Taipei City (TW)

(73) Assignee: National Taiwan Normal University, Taipei City (TW)

(21) Appl. No.: 16/249,414

(22) Filed: Jan. 16, 2019

(30) Foreign Application Priority Data
Aug. 23, 2018 (TW) 107129403

(51) Int. Cl. G01N 27/12

(52) U.S. Cl. CPC G01N 27/125

(57) ABSTRACT

A gas sensor includes a substrate, a pair of spaced-apart electrodes, and a detecting layer. The electrodes are disposed on the substrate with a region of the substrate exposed therefrom. Each of the electrodes is made of a graphene-based material. The detecting layer is disposed on the exposed region of the substrate and the electrodes. A method of making the gas sensor is also disclosed.

### CROSS-REFERENCE TO RELATED APPLICATION

This application claims priority to Taiwanese Invention Patent Application No. 107129403, filed on Aug. 23, 2018.

### FIELD

The disclosure relates to a gas sensor, and more particularly to a gas sensor including a pair of electrodes including graphene-based material, and a method of making the gas sensor.

### BACKGROUND

A gas sensor is commonly used for detecting alcohol, noxious gases or combustible gases, and is applicable indoors, such as gas detection inside a factory, and a breath alcohol test for environmental or health concerns.

Air pollution may harm human health and lead to a significant decrease in the quality of life. For instance, long-term living in an air polluted environment may induce lung lesions. In addition, studies have shown that composition of exhaled gas changes following infection with disease. If a person can detect the discharge of harmful gases in his/her surroundings or from self-breathing at any time, health hazard due to air pollution can be avoided. Hence, there is a tendency in the art to develop a miniaturized and portable gas sensor.

A conventional gas sensor is generally made by disposing metal layer and a detecting layer on a substrate using lithography techniques and vapor deposition techniques. The substrate is required to be heat-resistant. In addition, since the detecting layer of the conventional gas sensor is required to be heated or irradiated with an ultraviolet light during detection for enhancing sensitivity, the overall operation of the conventional gas sensor is relatively complicated, and is disadvantageous to be used as a portable gas sensor.

### SUMMARY

Therefore, an object of the disclosure is to provide a gas sensor that can alleviate at least one of the drawbacks of the prior art.

According to one aspect of the disclosure, a gas sensor includes a substrate, a pair of spaced-apart electrodes, and a detecting layer.

The electrodes are disposed on the substrate with a region of the substrate exposed therefrom. Each of the electrodes is made of a graphene-based material.

The detecting layer is disposed on the exposed region of the substrate and the electrodes.

According to another aspect of the disclosure, a method of making a gas sensor includes: forming an electrode-forming layer made from a graphene-based material on an electrically insulating substrate; patterning the electrode-forming layer using a pulsed laser to form a pair of spaced-apart electrodes and to expose a region of the electrically insulating substrate from the electrodes; and hydrothermally forming a detecting layer on the exposed region of the electrically insulating substrate and the electrodes.

### BRIEF DESCRIPTION OF THE DRAWINGS

Other features and advantages of the disclosure will become apparent in the following detailed description of the embodiments with reference to the accompanying drawings, of which:

FIG. 1 is a schematic view illustrating an embodiment of a gas sensor according to the disclosure;

FIGS. 2 to 6 are schematic views illustrating consecutive steps of an embodiment of a method of making a gas sensor according to the disclosure;

FIG. 7 is a scanning electron microscope (SEM) image illustrating a structure of a detecting layer of an example of the gas sensor;

FIG. 8 is a resistance-versus-time plot showing change in resistance of the example over time when the gas sensor is exposed to various concentrations of nitrogen monoxide; and

FIG. 9 is a response-versus-time plot showing response of the example when the gas sensor is sequentially subjected to cyclic exposures of nitrogen monoxide at different concentrations.

### DETAILED DESCRIPTION

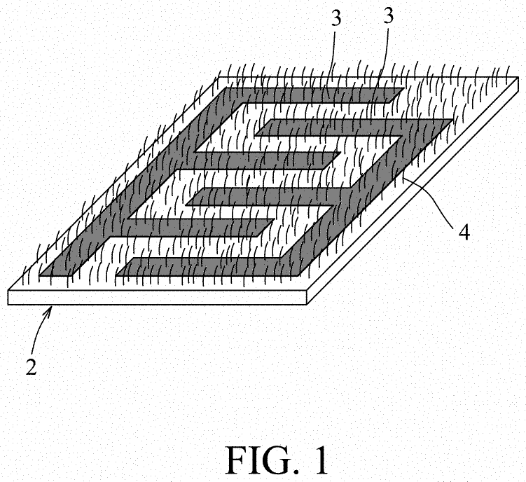

Referring to FIG. 1, an embodiment of a gas sensor according to the disclosure includes a substrate 2, a pair of spaced-apart electrodes 3 and a detecting layer 4.

The substrate 2 functions as a support and may be made from an electrically insulating material selected from the group consisting of polyethylene (PE), polyethylene terephthalate (PET), and polydimethylsiloxane (PDMS).

In the embodiment, the substrate 2 is flexible.

The electrodes 3 are disposed on the substrate 2 with a region of the substrate 2 exposed therefrom and are used for providing an electric current output. Each of the electrodes is made of a graphene-based material. In the embodiment, the graphene-based material includes graphene and an electrically conductive polymer. To be specific, the electrodes 3 are interdigitated electrodes, each of which is comb-shaped, and respectively serve as an anode and a cathode when a bias is applied thereto. One tooth of one of the interdigitated electrodes 3 serves as the anode and an adjacent one tooth of the other one of the interdigitated electrodes 3 serves as the cathode, so that the interdigitated electrodes 3 that cooperate with the detection layer 4 are wholly capable of forming a plurality of current paths. Therefore, the gas sensor has an increased area for electric current flow and an improved sensitivity for gas detection, accordingly.

The detecting layer 4 is disposed on the exposed region of the substrate 2 and the electrodes 3 and is used for absorbing a gas to be detected. In the embodiment, the detecting layer 4 is made of zinc oxide.

When the embodiment of the gas sensor is used for gas detection, the bias is applied to the electrodes 3 to generate the electric current flowing through the electrodes 3 and the detecting layer 4, and a gas to be detected is directed to flow through the detecting layer 4. Resistance values of the gas sensor during the gas detection are measured. Each of the resistance value measured after the gas to be detected is introduced, is compared with an initial resistance value of the gas sensor measured before the introduction of the gas to be detected, thereby obtaining a response.

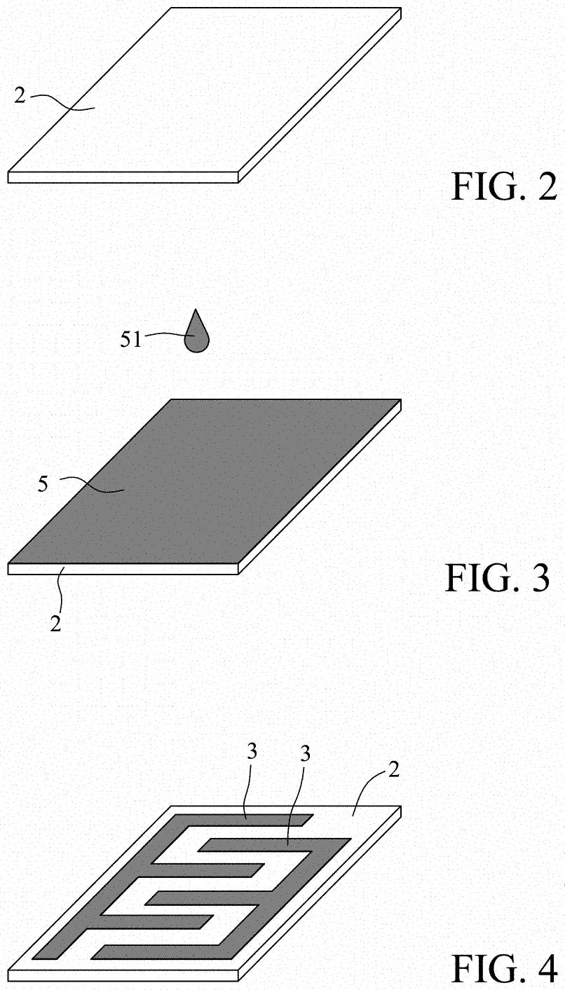

Referring to FIGS. 2 to 6, an embodiment of a method of making the embodiment of the gas sensor is mentioned as below. The method includes: forming an electrode-forming layer 5 made from a graphene-based material on the substrate 2; patterning the electrode-forming layer 5 using a pulsed laser to form a pair of the spaced-apart electrodes 3 and to expose a region of the substrate 2 from the electrodes 3; and hydrothermally forming the detecting layer 4 on the exposed region of the substrate 2 and the electrodes 3. In the embodiment, the substrate 2 is electrically insulating, and the detecting layer is hydrothermally formed at a temperature no greater than 90° C.

In the embodiment, the electrode-forming layer 5 is formed on the substrate 2 by spin-coating a graphene ink 51 on the substrate 2, and drying and baking the thus coated graphene ink 51. To be specific, the electrode-forming layer 5 is formed by: dispersing graphene particles in a solution containing electrically conductive polymer to form the graphene ink 51; spin-coating the graphene ink 51 on the substrate 2; and drying and baking the thus coated graphene ink 51 at a temperature ranging from 130° C. to 150° C. for two hours. Alternatively, the electrode-forming layer 5 may be formed by: dispersing the graphene particles in reactive monomers to form the graphene ink 51; spin-coating the graphene ink 51 on the substrate 2; and drying and baking the thus coated graphene ink 51 at a temperature higher than a hardening temperature of the reactive monomers. The electrically conductive polymer may be selected from the group consisting of poly(3,4-ethylenedioxythiophene) (PEDOT), polyphenylene sulfide (PSS), and polyaniline (PANI). The reactive monomers may be selected from the group consisting of 3,4-ethylenedioxythiophene (EDOT) and aniline. In addition, the graphene ink 51 may further include a thinner for reducing a viscosity thereof. The pulsed laser may be a femtosecond laser or a picosecond laser, and may have a pulse duration ranging from 10⁻¹⁵ seconds to 10⁻¹² seconds and a wavelength of 532 nm. Since the pulsed laser is operable to focus on a relatively small spot area, heat received by the graphene layer 5 is reduced, and thus a periphery of each of the electrodes 3 is smooth. Therefore, noise generated from the gas sensor during the gas detection is reduced.

To be specific, the detecting layer 4 is formed using a hydrothermal method which involves forming a zinc-oxide (ZnO) seed layer 41 on the exposed region of the substrate 2 and the electrodes 3 at a temperature ranging from 20° C. to 30° C., and hydrothermally growing a plurality of ZnO nanowires 42 on the ZnO seed layer 41 at a temperature ranging from 80° C. to 90° C. In the embodiment, the ZnO seed layer 41 is formed by dropwise dispensing a seed solution 6 on the exposed region of the substrate 2 and the electrodes 3.

The seed solution 6 includes zinc acetate dihydrate, triethylamine, isopropanol, and has a mole ratio of zinc acetate dihydrate to triethylamine being 1:1.

The ZnO nanowires 42 are grown by dipping the substrate 2 formed with the electrodes 3 and the ZnO seed layer 41 into an aqueous ZnO-growth solution 7 including hexamethylenetetramine, zinc nitrate hexahydrate and water. The aqueous ZnO-growth solution 7 has a molar concentration ratio of hexamethylenetetramine to zinc nitrate hexahydrate being 1:1, and a molar concentration of zinc nitrate hexahydrate not less than 0.01 M, so that the growth time of the ZnO nanowires 42 is reduced.

By way of forming the electrodes 3 using the pulsed laser in combination with forming the detecting layer 4 using the hydrothermal method, the method of making the gas sensor of the disclosure can be easily carried out and the manufacturing cost thereof can be reduced. Furthermore, compared with the conventional method of making the gas sensor that involves the lithography techniques and the vapor deposition techniques, the temperature used in making the gas sensor is relatively low. Therefore, the substrate 2 is permitted to be made from an electrically insulating polymeric material that is flexible, so that the gas sensor of the disclosure can take a portable or wearable form.

In the following, the manufacturing of an example of the gas sensor of the disclosure is mentioned below.

First, the graphene ink 51 (available from Enerage Inc., tradename: Graphene Ink I-MS18) was spin-coated on the substrate 2 that is made of PET and then was baked and dried at 150° C. for two hours to forma graphene layer that serves as the electrode-forming layer 5. Thereafter, the graphene layer 5 was patterned using the pulsed laser that has a pulse repetition frequency of 300 kHz, a speed of 500 mm/s, and an energy fluence of 1.35 J/cm² to form the interdigitated electrodes 3.

Subsequently, 1.1 g of zinc acetate dehydrate (Zn(CH₃CO₂)₂.2H₂O) was dissolved in 50 mL of isopropanol to forma Zn(CH₃CO₂)₂.2H₂O solution in isopropanol. Then, the Zn(CH₃CO₂)₂. 2H₂O solution in isopropanol was heated to a temperature of 85° C. with stirring for 15 minutes. Next, 700 mL of 5 mM triethylamine solution was added to the Zn(CH₃CO₂)₂. 2H₂O solution in isopropanol to form a first mixture. The first mixture was heated at 85° C. with stirring for 10 minutes, then cooled to room temperature and allowed to stand at the room temperature for 3 hours, subsequently obtaining the seed solution 6.

Next, 5.61 g of hexamethylenetetramine and 11.9 g of zinc nitrate hexahydrate were added in that order into 800 mL of a deionized water (DI water) to form a second mixture. Then, the second mixture was stirred at the room temperature for 24 hours for obtaining the aqueous ZnO-growth solution 7.

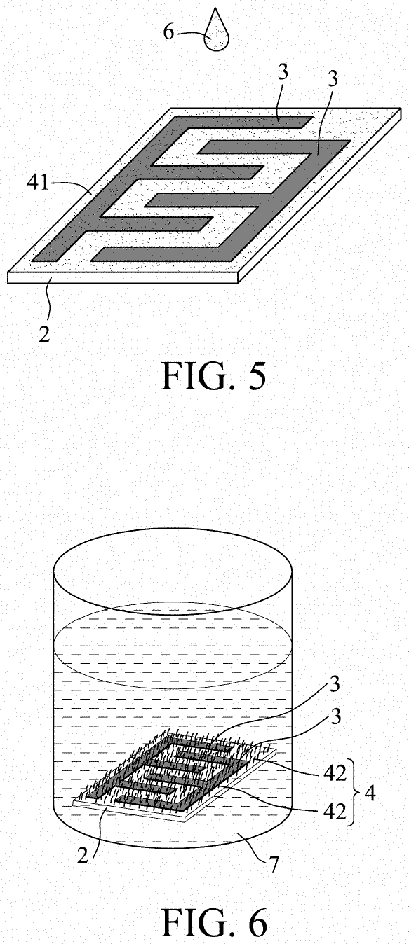

Thereafter, the seed solution 6 was dropwise dispensed on the electrodes 3 and the exposed region of the substrate 2 and then dried at the room temperature to obtain the ZnO seed layer 41. Afterwards, the substrate 2 formed with the electrodes 3 and the ZnO seed layer 41 was rinsed with ethanol, followed by dipping the same into the aqueous ZnO-growth solution 7 at 85° C. for 8 hours, so as to grow the ZnO nanowires 42 on the ZnO seed layer 41 (as shown in FIG. 7).

Alternatively, the seed solution 6 and the aqueous ZnO-growth solution 7 may be formed before the electrodes 3 are formed. The seed solution 6 may be prepared before or after the aqueous ZnO-growth solution 7 is prepared.

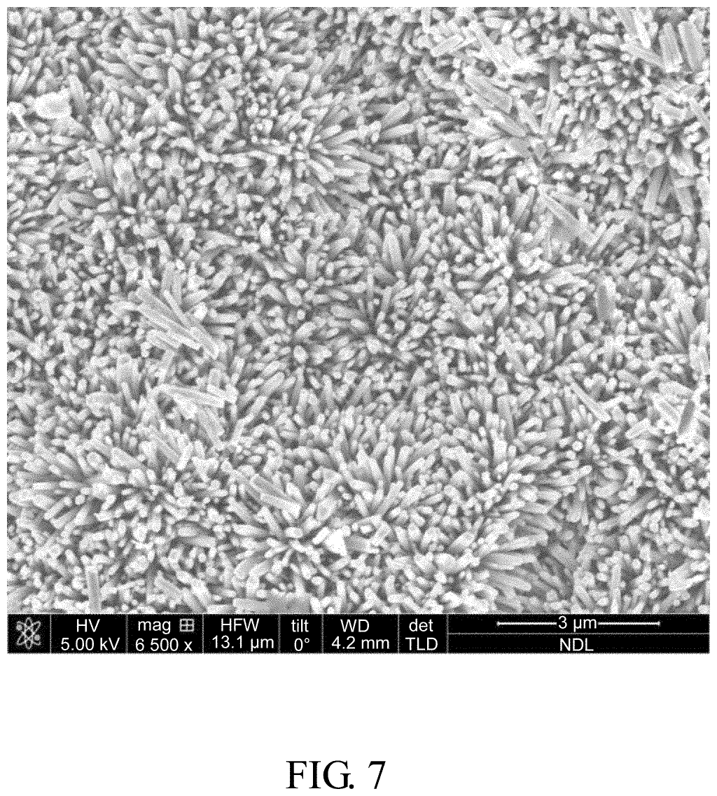

For evaluating the sensitivity of the gas sensor of the disclosure, the above example is alternately exposed to gases containing nitrogen monoxide at different concentrations at 25° C., and change in resistance thereof over time is recorded and shown in the resistance-versus-time plot of FIG. 8. To be specific, in a first time period (I), the example is in a vacuum; in a second time period (II), the example is exposed to 150 ppm of nitrogen monoxide; in a third time period (III), the example is exposed to nitrogen gas to eliminate any residual nitrogen monoxide; in a fourth time period (IV), the example is exposed to 300 ppm of nitrogen monoxide; and in the fifth time period (V), the example is once again exposed to the nitrogen gas. From the results shown in FIG. 8, it is evident that the example of the gas sensor of the disclosure has high sensitivity and is capable of sensing the presence and concentration difference of the gas to be detected.

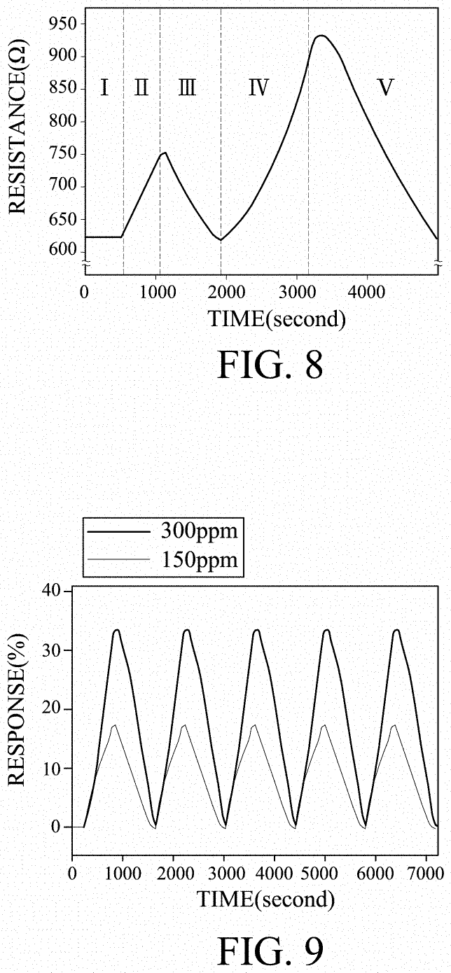

For evaluating precision and durability of the gas sensor of the disclosure, the above example is sequentially subjected to five cycles of alternate exposures to 150 ppm of nitrogen monoxide and nitrogen gas, and five cycles of alternate exposures to 300 ppm of nitrogen monoxide and nitrogen gas. Response of the example over time for each exposure is recorded and shown in the response-versus-time plot of FIG. 9. From the results shown in FIG. 9, difference in the response values of the five cycles of the alternate exposures to 150 ppm of nitrogen monoxide and nitrogen gas is minimal, and difference in the response values of the five cycles of the alternate exposures to 300 ppm of nitrogen monoxide and nitrogen gas is also minimal. Therefore, it is evident that the gas sensor of the disclosure exhibits excellent precision and durability.

To sum up, by virtue of using the electrodes 3 made of the graphene-based material in combination with the detecting layer 4 made using the hydrothermal method, the conductivity of the electrodes 3 is increased so as to improve the sensitivity of the gas sensor, and the making and the detecting operation of the gas sensor can be carried out at a relatively low temperature, such as the ambient temperature. Besides, the gas sensor is applicable to portable or wearable gas sensing devices when the substrate 2 is flexible.

In the description above, for the purposes of explanation, numerous specific details have been set forth in order to provide a thorough understanding of the embodiment). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A gas sensor, comprising:
a substrate;
a pair of spaced-apart electrodes disposed on said substrate with a region of said substrate exposed therefrom, each of said electrodes being made of a graphene-based material; and
a detecting layer disposed on the exposed region of said substrate and said electrodes.

2. The gas sensor of claim 1, wherein said substrate is flexible.

3. The gas sensor of claim 1, wherein said substrate is made from an electrically insulating material selected from the group consisting of polyethylene, polyethylene terephthalate, and polydimethyloxane.

4. The gas sensor of claim 1, wherein said electrodes are interdigitated electrodes.

5. The gas sensor of claim 1, wherein the detecting layer is made of zinc oxide.

6. A method of making a gas sensor, comprising:
forming an electrode-forming layer made of a graphene-based material on an electrically insulating substrate;
patterning the electrode-forming layer using a pulsed laser to form a pair of spaced-apart electrodes and to expose a region of the electrically insulating substrate from the electrodes; and
forming a detecting layer using a hydrothermal method on the exposed region of the electrically insulating substrate and the electrodes.

7. The method of claim 6, wherein the detecting layer is hydrothermally formed at a temperature no greater than 90° C.

8. The method of claim 6, wherein the electrode-forming layer is spin-coated on the substrate, the graphene-based material being a graphene ink.

9. The method of claim 6, wherein the pulsed laser has a pulse duration ranging from 10⁻¹⁵ seconds to 10⁻¹² seconds.

10. The method of claim 6, wherein the detecting layer is formed by forming a zinc-oxide seed layer on the exposed region of the substrate and the electrodes at a temperature ranging from 20° C. to 30° C., and hydrothermally growing a plurality of zinc-oxide (ZnO) nanowires on the ZnO seed layer at a temperature ranging from 80° C. to 90° C.

11. The method of claim 10, wherein the ZnO seed layer is formed by dropwise dispensing a seed solution on the exposed region of the substrate and the electrodes, the seed solution including zinc acetate dihydrate, triethylamine and isopropanol, and having a mole ratio of zinc acetate dihydrate to triethylamine being 1:1.

12. The method of claim 10, wherein the ZnO nanowires are grown by dipping the substrate formed with the electrodes and the ZnO seed layer into an aqueous ZnO-growth solution including hexamethylenetetramine and zinc nitrate hexahydrate, the aqueous ZnO-growth solution having a molar concentration ratio of hexamethylenetetramine to zinc nitrate hexahydrate being 1:1 and a molar concentration of zinc nitrate hexahydrate not less than 0.01 M.
